(19) United States
(12) Patent Application Publication
(10) Pub. No.: US 2016/0123070 A1
(43) Pub. Date: May 5, 2016

(54) Automatic Cord Inserting Structure for a Venetian Blind

(71) Applicant: Jorher Industrial Co .. Ltd., Changhua County 51343 (TW)

(72) Inventor: Shou-Po Wu, Changhua County (TW)

(21) Appl. No.: 14/526,834

(22) Filed: Oct. 29, 2014

(51) Int. Cl. E06B 9/266

(52) U.S. Cl. CPC E06B 9/266

(57) ABSTRACT

An automatic cord inserting structure for a venetian blind is fixed on an automatic slat insertion machine including a pushing mechanism and a slat fixing mechanism. The pushing mechanism pushes a slat toward the slat fixing mechanism, and the slat fixing mechanism includes a sliding rack and plural automatic infixing modules. Each automatic infixing module contains: a base having a front face, a rear face, a horizontal slot, and a vertical slot; two limiting pieces for limiting the cord assembly slid in the vertical slot; two abutting pieces fixed in the horizontal slot, and each abutting piece having a lock portion locked on the base and a contacting portion; two elastic units mounted among the base and the two abutting pieces to abut against the two abutting pieces, when the abutting pieces are not pushed by the slat, they are fixed in the horizontal slot.

### BACKGROUND OF THE INVENTION

1. Field of the Invention

The present invention relates to a cord inserting structure for a venetian blind, and more particularly to an automatic cord inserting structure for a venetian blind which automatically pulls a cord assembly tightly to insert a slat easily.

2. Description of the Prior Art

A louver curtain for doors and windows is comprised of plural elongated slats. To arrange the plural elongated slats in order, adjust an angle of the plural slats, and vertically move the plural slats, a cord assembly is connected based on a width of the slat. Referring to FIG. 14, the cord assembly 4 contains two vertical cords 41 and a plurality of locking cords 42 separately connected with the two vertical cords 41, each locking cord 42 has a first section 421 and a second section 422 between which is defined a gap 423 for inserting a slat.

However, the cord assembly 4 is flexible, and the gap 423 of each locking cord 42 is so narrow that the slat is not inserted into the gap 423 easily, a specific machine is therefore applied to insert the slat into the gap 423 of each locking cord 42, and the slat is arranged on a holder so that the gap 423 of each locking cord 42 of the cord assembly 4 is manually fitted with two ends of the slat, thereby consuming labor.

The present invention has arisen to mitigate and/or obviate the afore-described disadvantages.

### SUMMARY OF THE INVENTION

The primary objective of the present invention is to provide an automatic cord inserting structure for a venetian blind which expands a cord assembly by ways of two abutting pieces so that a slat is inserted into the cord assembly easily and quickly, thus obtaining mass production and reducing labor cost.

To obtain above-mentioned objectives, an automatic cord inserting structure for a venetian blind provided by the present invention is fixed on an automatic slat insertion machine for the venetian blind, and the automatic slat insertion machine includes a pushing mechanism and a slat fixing mechanism, the pushing mechanism pushes a slat toward the slat fixing mechanism, the slat fixing mechanism includes a sliding rack and plural automatic infixing modules arranged on the sliding rack, and each automatic infixing module contains: a base, two limiting pieces, two abutting. pieces, and two elastic units.

The base has a front face, a rear face, a horizontal slot formed on a first top end thereof to insert the slat, and a vertical slot formed on the front face to slide a cord assembly.

The two limiting pieces are locked on the front face of the base and limit the cord assembly slid in the vertical slot.

Each abutting piece has a lock portion and a contacting portion, wherein the lock portion are locked on the base, and the two abutting pieces are normally fixed in the horizontal slot of the base, and when the slat is fixed in the horizontal slat, the two abutting pieces are pushed by the slat to rotate, the two contacting portions of the two abutting pieces extend out of the front face of the base to pull the cord assembly tightly, thus inserting the slat into the cord assembly.

The two elastic units are mounted among the base and the two abutting pieces to abut against the two abutting pieces, and when the abutting pieces are not pushed by the slat, they are fixed in the horizontal slot of the base automatically.

### BRIEF DESCRIPTION OF THE DRAWINGS

FIG. 1 is a perspective view showing the assembly of an automatic cord inserting structure for a venetian blind according to a preferred embodiment of the present invention.

FIG. 2 is a perspective view showing the assembly of an automatic infixing module of the automatic cord inserting structure for the venetian blind according to the preferred embodiment of the present invention.

FIG. 3 is a perspective view showing the exploded components of the automatic infixing module of the automatic cord inserting structure for the venetian blind according to the preferred embodiment of the present invention.

FIG. 4 is a top plan view showing the operation of the automatic infixing module of the automatic cord inserting structure for the venetian blind according to the preferred embodiment of the present invention.

FIG. 5 is a front plan view showing the operation of the automatic infixing module of the automatic cord inserting structure for the venetian blind according to the preferred embodiment of the present invention.

FIG. 6 is another top plan view showing the operation of the automatic infixing module of the automatic cord inserting structure for the venetian blind according to the preferred embodiment of the present invention.

FIG. 7 is a top plan view showing the operation of the automatic cord inserting structure for the venetian blind according to the preferred embodiment of the present invention.

FIG. 8 is a front plan view showing the operation of the automatic cord inserting structure for the venetian blind according to the preferred embodiment of the present invention.

FIG. 9 is a partial plan view showing the operation of the automatic cord inserting structure for the venetian blind according to the preferred embodiment of the present invention.

FIG. 10 is a perspective view showing the assembly of an automatic infixing module of an automatic cord inserting structure for a venetian blind according to another preferred embodiment of the present invention.

FIG. 11 is a top plan view showing the operation of the automatic infixing module of the automatic cord inserting structure for the venetian blind according to another preferred embodiment of the present invention.

FIG. 12 is a front plan view showing the operation of the automatic infixing module of the automatic cord inserting structure for the venetian blind according to another preferred embodiment of the present invention.

FIG. 13 is a front plan view showing the operation of the automatic cord inserting structure for the venetian blind according to another preferred embodiment of the present invention.

FIG. 14 is a plan view of a conventional cord assembly.

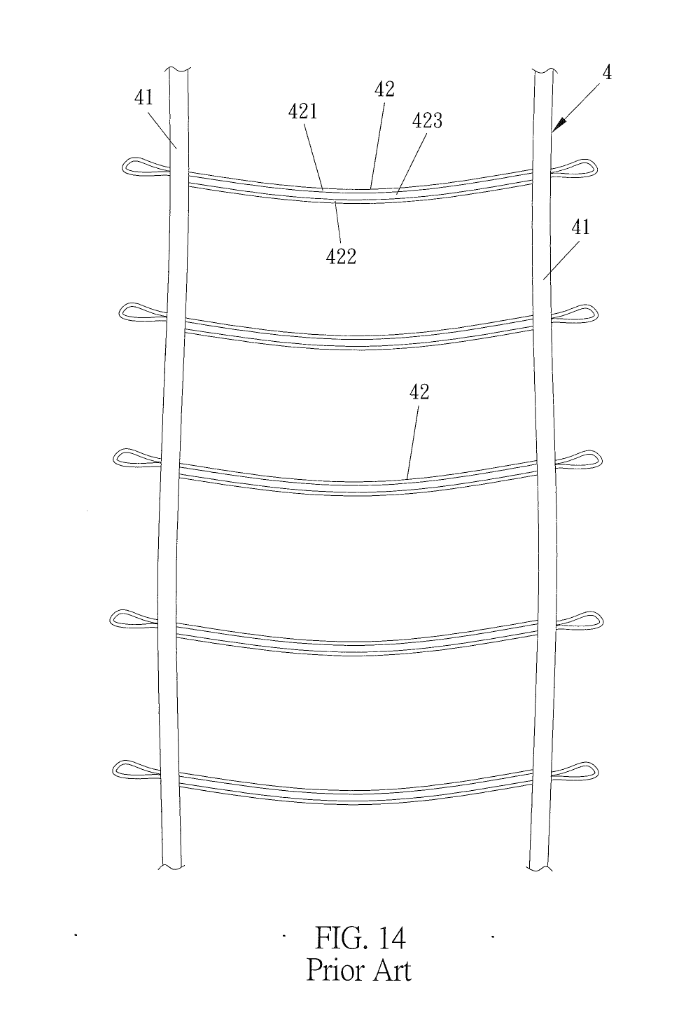

### DETAILED DESCRIPTION OF THE PREFERRED

### Embodiments

The present invention will be clearer from the following description when viewed together with the accompanying drawings, which show, for purpose of illustrations only, a preferred embodiment in accordance with the present invention.

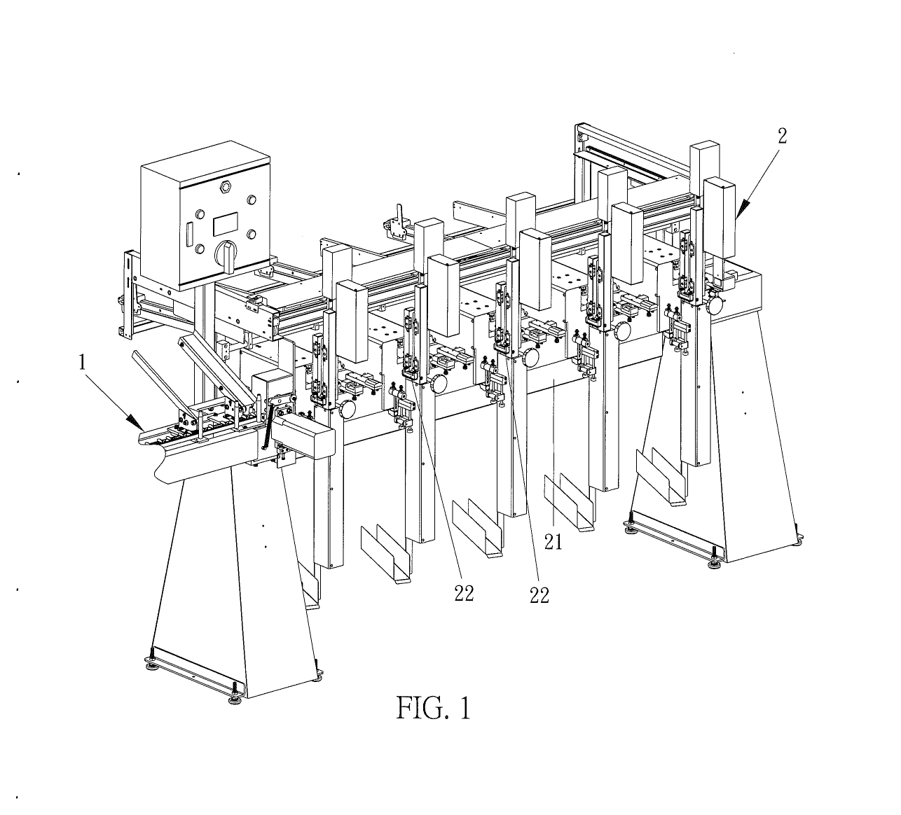

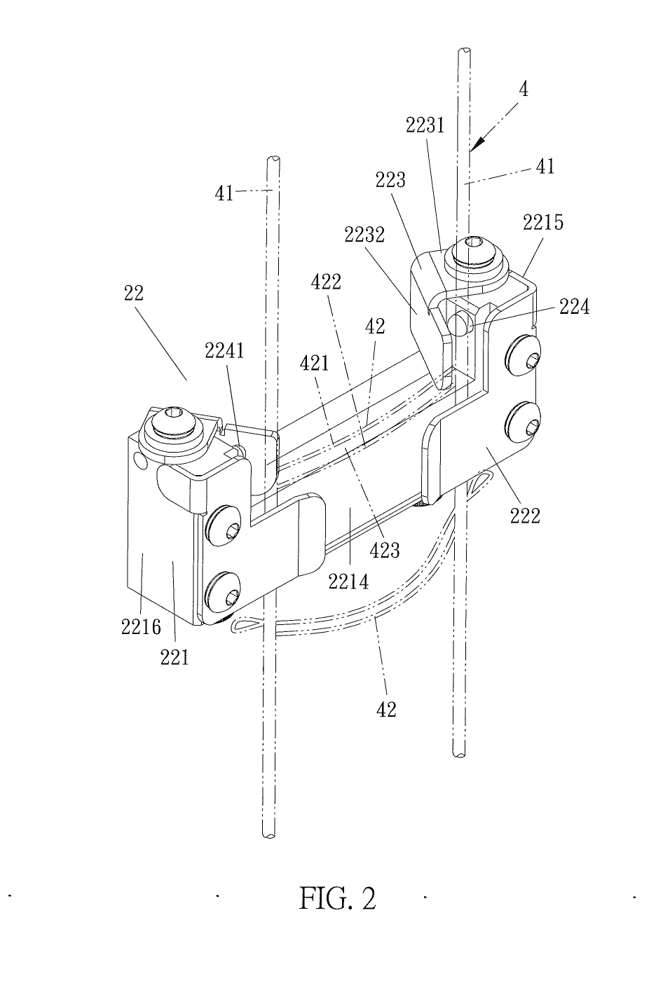

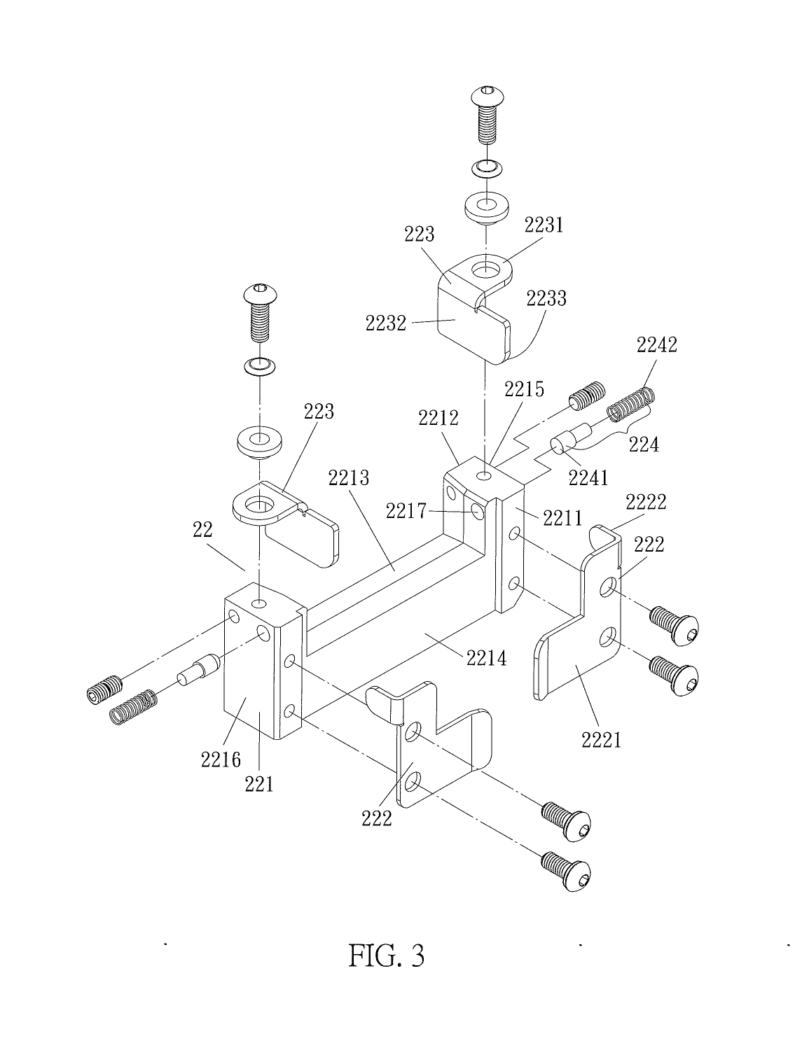

With reference to FIGS. 1 to 3, an automatic cord inserting structure for a venetian blind according to a preferred embodiment of the present invention is fixed on an automatic slat insertion machine for a venetian blind and the automatic slat insertion machine includes a pushing mechanism 1 and a slat fixing mechanism 2, the pushing mechanism 1 supports and pushes a slat 3 toward the slat fixing mechanism 2 to connect with a cord assembly 4, wherein the cord assembly 4 includes two vertical cords 41 and a plurality of locking cords 42 separately connected with the two vertical cords 41, each locking cord 42 has a first section 421 and a second section 422 between which is defined a gap 423 for inserting the slat 3. The slat fixing mechanism 2 includes a sliding rack 21 and plural automatic infixing modules 22 arranged on the sliding rack 21 to insert the slat 3 into the cord assembly 4, wherein each automatic infixing module 22 is slid toward a desired position based on a length of the slat 3 and has a base 221, two limiting pieces 222, two abutting pieces 223, and two elastic units 224. The base 221 has a front face 2211, a rear face 2212, a horizontal slot 2213 formed on a first top end thereof to insert the slat 3, a vertical slot 2214 formed on the front face 2211 to slide the cord assembly 4, wherein the two limiting pieces 222 are locked on the front face 2211 of the base 221, and each limiting piece 222 has a defining portion 2221 extending toward a front side of the longitudinal slot 2214 of the base 221 to limit the cord assembly 4 slid in the vertical slot 2214. Each abutting piece 223 has a lock portion 2231 and a contacting portion 2232, wherein the lock portion 2231 contacts with a top surface of two sides of the horizontal slot 2213 of the base 221, such that the two abutting pieces 223 are movably rotated. Each contacting portion 2232 has a first arcuate guiding portion 2233 defined on one end thereof away from the lock portion 2231, the two elastic units 224 are mounted among the base 221 and the two abutting pieces 223 to abut against the two abutting pieces 223, two contacting portions 2232 of the two abutting pieces 223 are normally fixed in the horizontal slot 2213 of the base 221, and when the two abutting pieces 223 are pushed by the slat 3 to rotate, the two contacting portions 2232 of the two abutting pieces 223 extend out of the front face of the base 221.

The base 221 of each automatic infixing module 22 also has a left face 2215, a right face 2216, and two through holes 2217 defined on the left face 2215 and the right face 2216 and communicating with the horizontal slot 2213. Each elastic unit 224 has a resilient resisting element 2241 and a spring 2242 which are mounted in each through hole 2217 of the base 221, wherein the resilient resisting element 2241 is pushed by the spring 2242 to push each abutting piece 223 via the horizontal slot 2213 of the base 221. Two limiting pieces 222 have two shoulders 2222 extending toward the left face 2215 and the right face 2216 of the base 211 to stop the two elastic units 224 removing from the two through holes 2217 of the base 221.

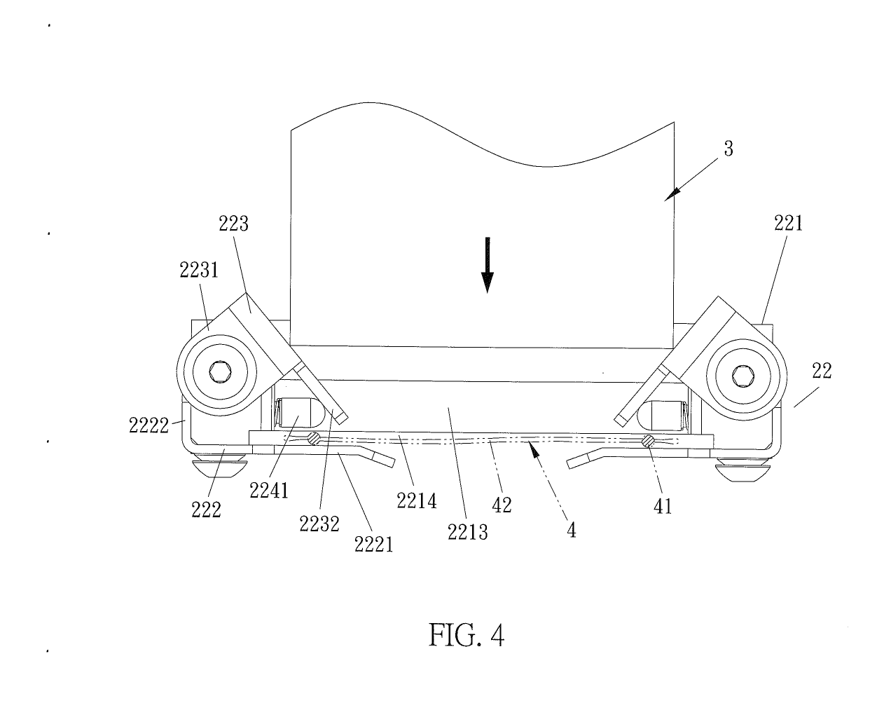

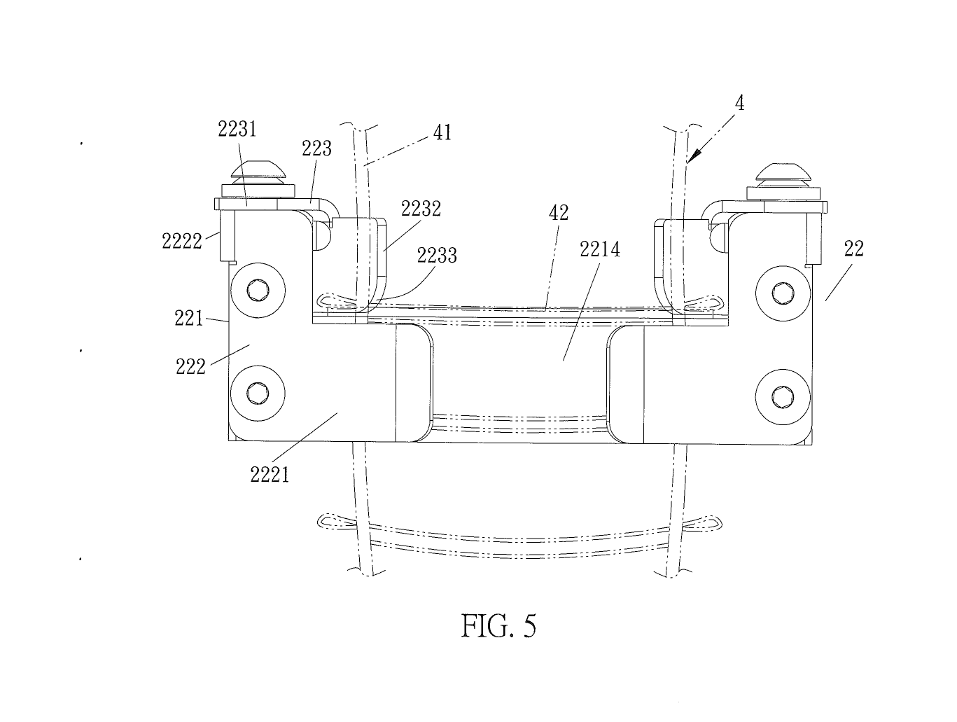

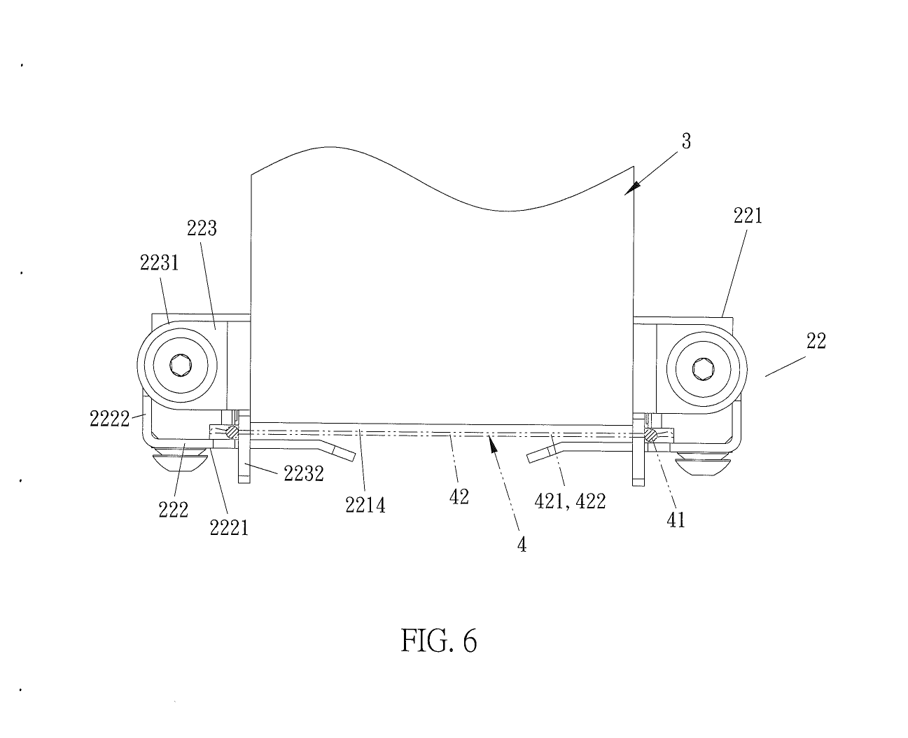

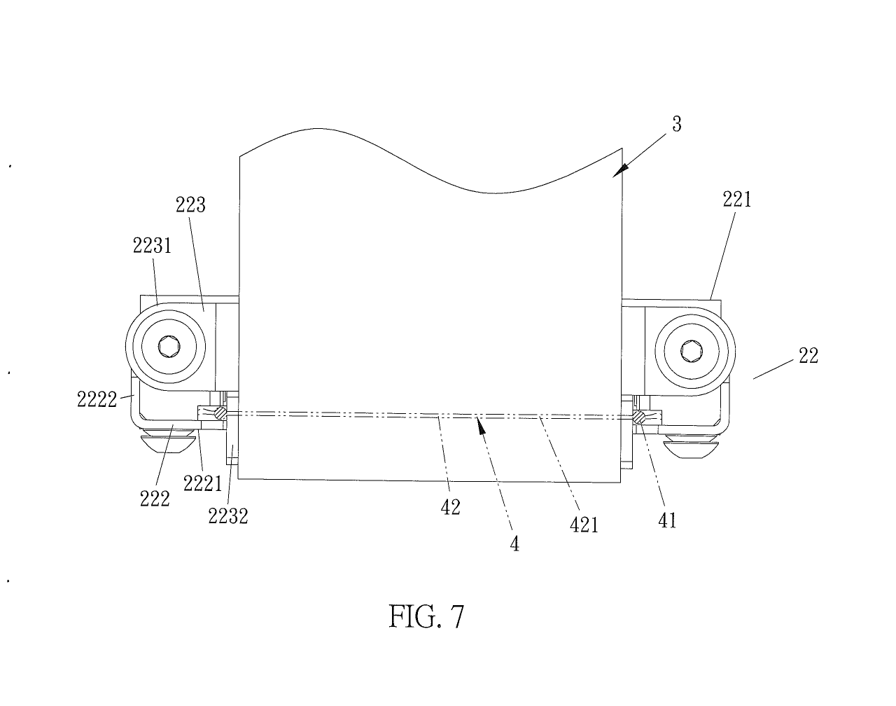

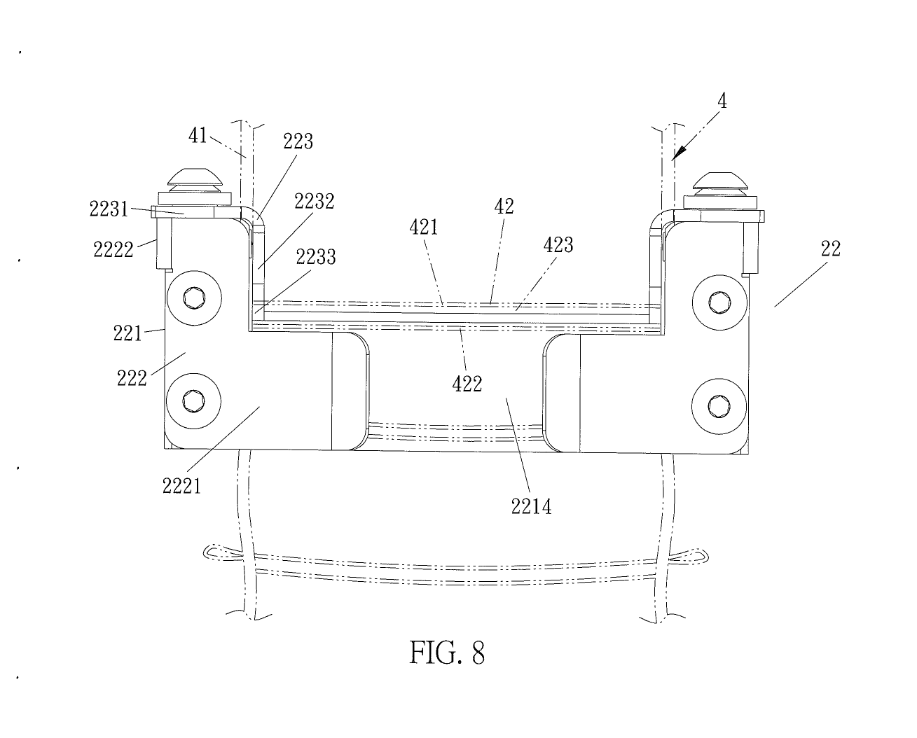

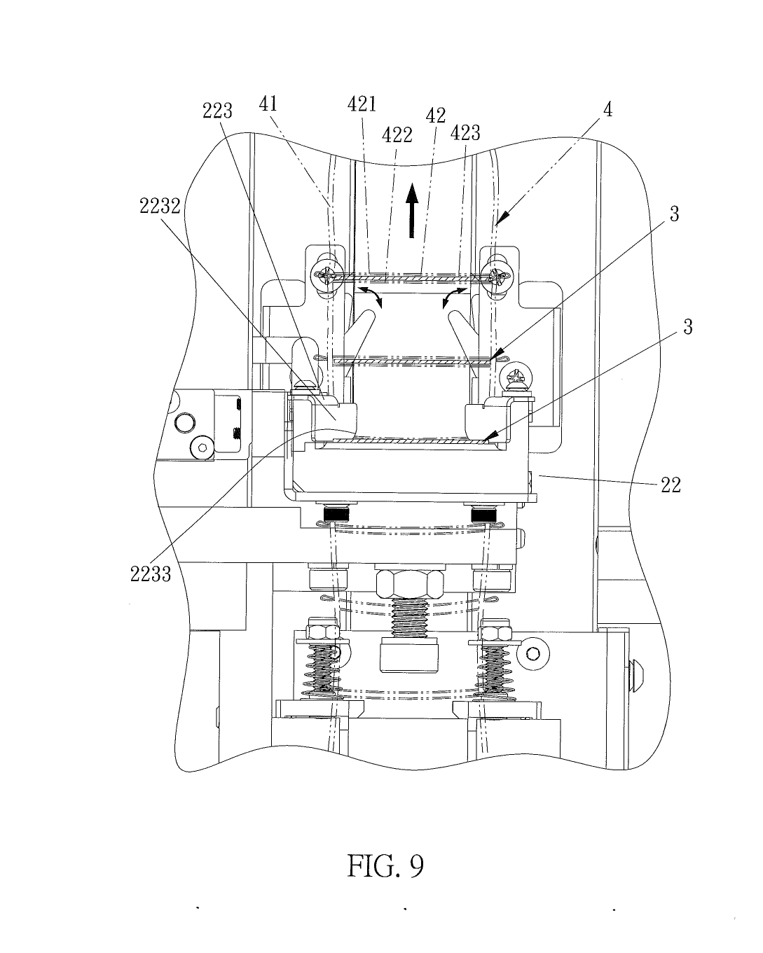

In operation, the pushing mechanism 1 pushes the slat 3 toward the slat fixing mechanism 2, as shown in FIGS. 4 and 5, and when the slat 3 is fixed in the horizontal slot 2213 of the base 221 of each automatic infixing module 22, two edges of one end of the slat 3 push the two abutting pieces 223 to rotate frontward to the base 221, as illustrated in FIG. 6, such that the two contacting portions 2232 of the two abutting pieces 223 extend over the front face of the base 221 to push the cord assembly 4 tightly and to expand the gap 423 between the first section 421 and the second section 422 of each locking cord 42, hence the slat 3 inserts through the gap 423 of each locking cord 42, as illustrated in FIGS. 7 and 8. With reference to FIG. 9, after the slat 3 inserts through the cord assembly 4, two first arcuate guiding portions 2233 of the two abutting pieces 223 guide the cord assembly 4 to move upwardly with the slat 3 at a spacing height of a locking cord 42, thus inserting the slat 3 of the venetian blind.

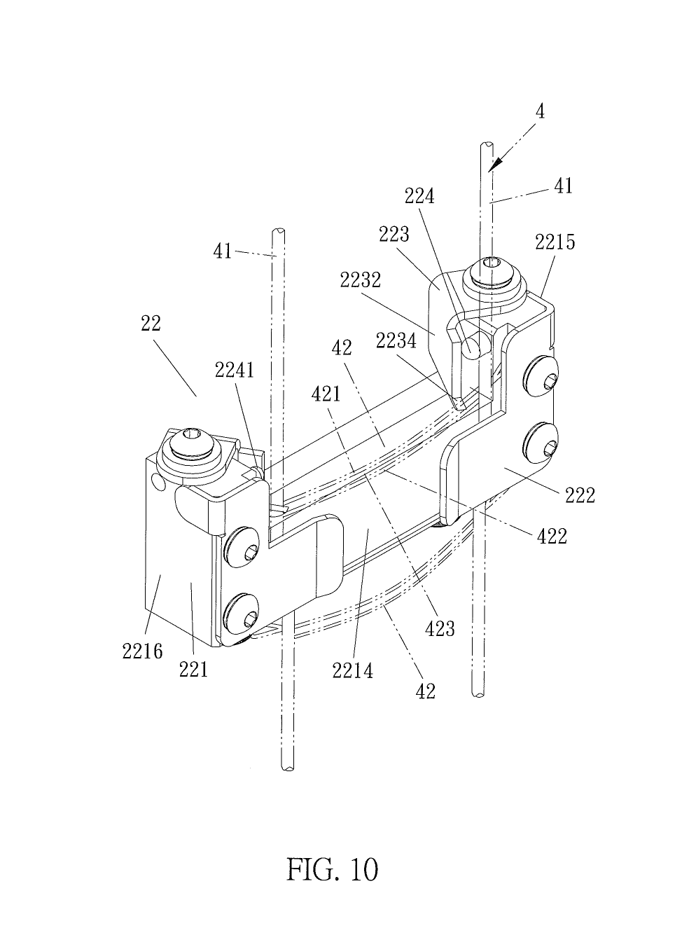

Referring to FIG. 10, each contacting portion 2232 of two each abutting piece 223 of each automatic infixing module 22 also has a rotating bar 2234 disposed on the one end thereof away from the lock portion 2231, and the rotating bar 2234 has a second arcuate guiding portion 2235 mounted on a lower corner of one end thereof away from the lock portion 2231.

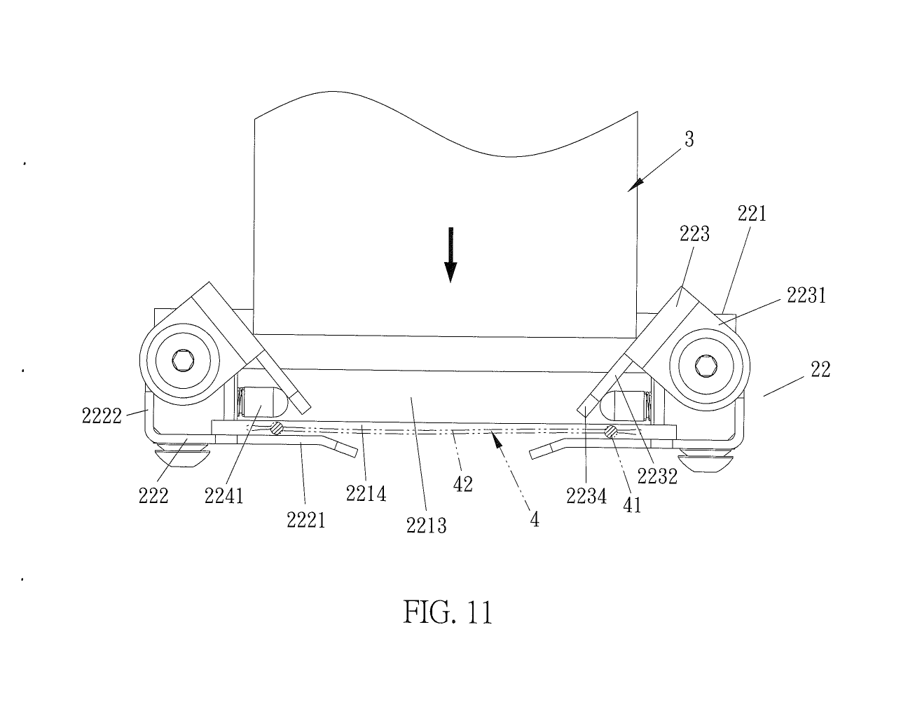

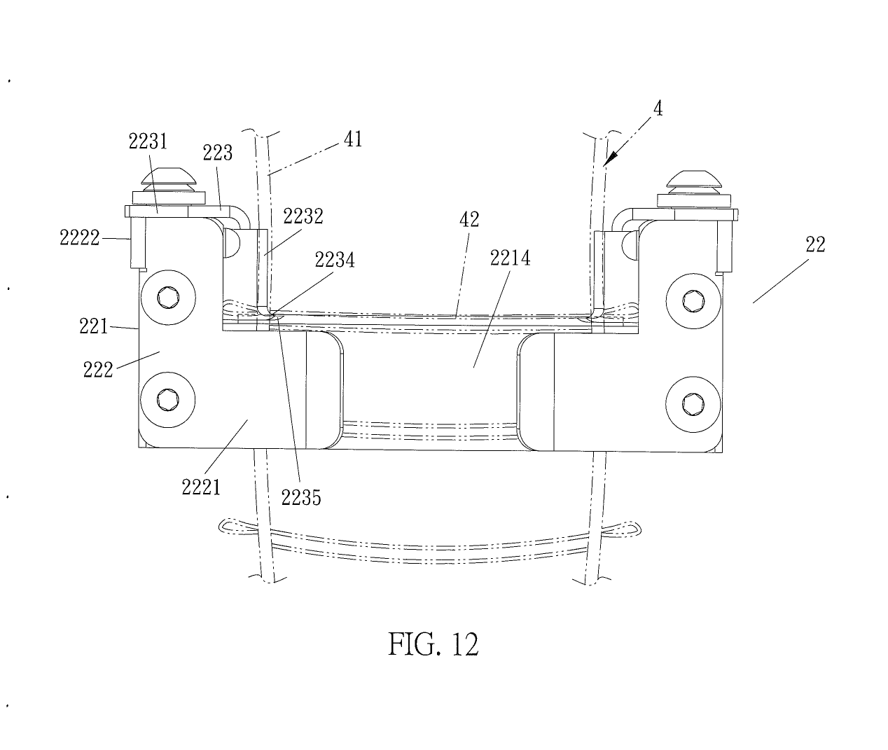

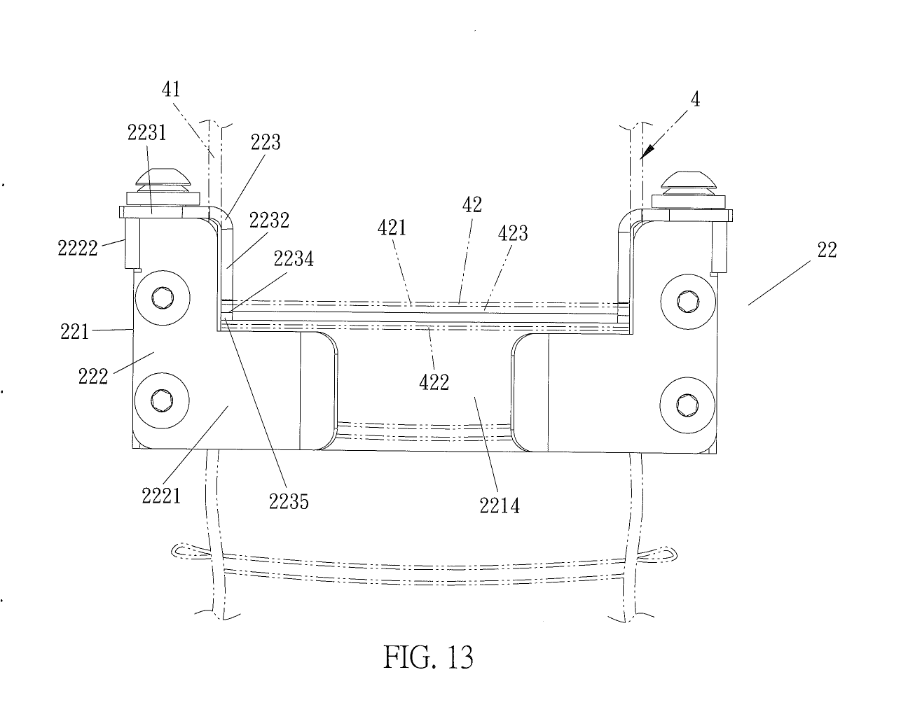

As inserting the cord assembly 4, the pushing mechanism 1 pushes the slat 3 toward the slat fixing mechanism 2, as shown in FIGS. 11 and 12, and when the slat 3 is fixed in the horizontal slot 2213 of the base 221 of each automatic infixing module 22, the two edges of one end of the slat 3 push the two abutting pieces 223 to rotate frontward to the base 221, as illustrated in FIG. 13, and two rotating bars 2234 of the two abutting pieces 223 extend over the front face of the base 221 and insert into the gap 423 of each locking cord 42 of the cord assembly 4 to pull the cord assembly 4 tightly, such that the gap 423 between the first section 421 and the second section 422 of each locking cord 42 is expanded to insert the slat 3 easily.

Thereby, the automatic cord inserting structure for the venetian blind expands the cord assembly 4 by ways of the two abutting pieces 223 so that the slat 3 is inserted into the gap 423 of each locking cord 42 of the cord assembly 4 easily and quickly, thus obtaining mass production and reducing labor cost.

While various embodiments in accordance with the present invention have been shown and described, it is clear to those skilled in the art that further embodiments may be made without departing from the scope of the present invention.

What is claimed is:

1. An automatic cord inserting structure for a venetian blind being fixed on an automatic slat insertion machine for the venetian blind, and the automatic slat insertion machine including a pushing mechanism and a slat fixing mechanism, the pushing mechanism pushing a slat toward the slat fixing mechanism, the slat fixing mechanism including a sliding rack and plural automatic infixing modules arranged on the sliding rack, and each automatic infixing module having:
a base having a front face, a rear face, a horizontal slot formed on a first top end thereof to insert the slat, and a vertical slot formed on the front face to slide a cord assembly;
two limiting pieces locked on the front face of the base and limiting the cord assembly slid in the vertical slot;
two abutting pieces, each abutting piece having a lock portion and a contacting portion, wherein the lock portion are locked on the base, and the two abutting pieces are normally fixed in the horizontal slot of the base, and when the slat is fixed in the horizontal slat, the two abutting pieces are pushed by the slat to rotate, the two contacting portions of the two abutting pieces extend out of the front face of the base to pull the cord assembly tightly, thus inserting the slat-into the cord assembly; and
two elastic units mounted among the base and the two abutting pieces to abut against the two abutting pieces, and when the abutting pieces are not pushed by the slat, they are fixed in the horizontal slot of the base automatically.

2. The automatic cord inserting structure for the venetian blind as claimed in claim 1, wherein the base of each automatic infixing module also has a left face, a right face, and two through holes defined on the left face and the right face and communicating with the horizontal slot to accommodate the two elastic units.

3. The automatic cord inserting structure for the venetian blind as claimed in claim 1, wherein each limiting piece has a defining portion extending toward a front side of the longitudinal slot of the base to limit the cord assembly slid in the vertical slot.

4. The automatic cord inserting structure for the venetian blind as claimed in claim 2, wherein the two limiting pieces have two shoulders extending toward the left face and the right face of the base to stop the two elastic units removing from the two through holes of the base.

5. The automatic cord inserting structure for the venetian blind as claimed in claim 1, wherein each contacting portion has a first arcuate guiding portion defined on one end thereof away from the lock portion.

6. The automatic cord inserting -structure for the venetian blind as claimed in claim 2, wherein each elastic unit has a resilient resisting element and a spring which are mounted in each through hole of the base, wherein the resilient resisting element is pushed by the spring to push each abutting piece via the horizontal slot of the base.

7. The automatic cord inserting structure for the venetian blind as claimed in claim 1, wherein each contacting portion also has a rotating bar disposed on the one end thereof away from the lock portion.

8. The automatic cord inserting structure for the venetian blind as claimed in claim 7, wherein the rotating bar has a second arcuate guiding portion mounted on a lower corner of one end thereof away from the lock portion.
